(19) United States
(12) Patent Application Publication
(10) Pub. No.: US 2007/0211011 A1
(43) Pub. Date: Sep. 13, 2007

(54) FLAT PANEL DISPLAY DEVICE AND DATA SIGNAL GENERATING METHOD THEREOF

(76) Inventor: Chul Ho Lee, Cheonan-si (KR)

Correspondence Address: CHRISTIE, PARKER & HALE, LLP, PO BOX 7068, PASADENA, CA, 91109-7068, US

(21) Appl. No.: 11/681,119

(22) Filed: Mar. 1, 2007

(30) Foreign Application Priority Data
Mar. 9, 2006 (KR) 10-2006-0022182

(51) Int. Cl. G09G 3/36

(52) U.S. Cl. 345/100

(57) ABSTRACT

A flat panel display device and a data signal generating method thereof, in which data signals are different in voltage levels, thereby enhancing efficiency of representing a gray level and reducing power consumption. The flat panel display device includes: a display region for receiving a data signal and a scan signal to display an image; a data driver for generating the data signal based on a video signal and for supplying the data signal to the display region; and a scan driver for generating the scan signal and for supplying the scan signal to the display region, wherein the data driver is adapted to adjust a voltage level of the data signal by at least one upper bit of the video signal and to adjust a pulse width of the data signal by at least one lower bit of the video signal to control brightness.

### CROSS-REFERENCE TO RELATED APPLICATION

This application claims priority to and the benefit of Korean Patent Application No. 10-2006-0022182, filed on Mar. 9, 2006, in the Korean Intellectual Property Office, the entire content of which is incorporated herein by reference.

### BACKGROUND

1. Field of the Invention

The present invention relates to a flat panel display device and a data signal generating method thereof, and more particularly, to a flat panel display device and a data signal generating method thereof, in which the amplitude and the pulse width of a data signal are controlled to adjust a gray level of the data signal.

2. Discussion of Related Art

A flat panel display device can be classified into an active matrix type and a passive matrix type according to its structure, and can also be classified into a memory driving type and a non-memory driving type according to its light emitting principle. In general, the active matrix type is similar to the memory driving type, and the passive matrix type is similar to the non-memory driving type. In the active matrix type and the memory driving type, light is emitted per a unit of frame. In the passive matrix type and the non-memory driving type, the light is emitted per a unit of line.

In more detail, a passive matrix type flat panel display device is a display device in which horizontal lines are selected in sequence and uses a line scan method of emitting light only when the selected line of the horizontal lines is selected. In one embodiment, the passive matrix type flat panel display device uses a pulse width modulation (PWM) method to control a pulse width of a data signal to adjust its brightness.

FIG. 1 is a block diagram of a conventional data driver that generates a data signal based on a PWM method. Referring to FIG. 1, the data driver includes a shift register 11, a latch 12, a counter 13, a comparator 14, a level shifter 15, and a buffer 16.

The shift register 11 receives video signals in series and transmits the video signals to the latch 12. The latch 12 receives the video signals in series and outputs them in parallel to the comparator 14. The counter 13 uses clocks CLK to count numbers from ‘255’ to ‘0’ when the video signal has an input gray scale of 8 bits. Here, the counter 13 either uses an up counter that counts in order of ‘0,’ ‘1,’ ‘2,’ ‘3,’ . . . , ‘254,’ ‘255,’ or a down counter that counts in order of ‘255,’ ‘254,’ ‘253,’ . . . , ‘1,’ ‘0.’ Alternatively, both the up counter and the down counter may be used as the counter 13. When both the up counter and the down counter are used, the down counter operates first and the up counter starts operating when the down counter finishes counting. The comparator 14 compares the number input from the latch 12 with the number counted by the counter 13, and outputs a signal when the value of the video signal corresponds (is coincident) with the value of the counter 13. In the case where the counter 13 employs both the up counter and the down counter, the comparator 14 first compares the number counted by the down counter with the value of the video signal and outputs a signal when they correspond (or are coincident) with each other. In the state that the signal output from the comparator 14 is maintained, the up counter starts counting when the down counter finishes counting. Then, the comparator 14 compares the number counted by the up counter with the value of the video signal and stops outputting the signal when they correspond (or are coincident) with each other. Here, the signal output from the comparator 14 is transmitted to the buffer 16 via the level shifter 15, thereby allowing the data signal to be generated.

FIGS. 2A, 2B, and 2C are timing diagrams illustrating PWM driving methods of the conventional data driver shown in FIG. 1. FIG. 2A is a timing diagram of when the counter of the data driver uses both the down counter and the up counter; FIG. 2B is a timing diagram of when the counter of the data driver uses only the down counter; and FIG. 2C is a timing diagram of when the counter of the data driver uses only the up counter. The data driver generates a data signal of representing a gray scale of 8 bits. During the time period that one line emits light (or one line on-time), the data driver controls an emission time of a pixel according to input gray levels of the video signals, thereby representing each of the gray levels.

Referring to FIG. 2A, during an on-time of one line (or one line on-time), the data driver drives the down counter to count clocks from ‘255’ to ‘0’ and then the up counter to count clocks from ‘0’ to ‘255’. In the case where the video signal has an input gray level of ‘0,’ the data driver controls the voltage of the data signal to have a ground voltage, thereby representing the gray level of ‘0.’ In the case where the video signal has an input gray level of ‘1,’ the data driver controls the voltage of the data signal to have a voltage Vpp between a time period when the down counter counts ‘1’ and when the up counter counts ‘1.’ In the case where the video signal has an input gray level of ‘255,’ the data driver controls the voltage of the data signal to have the voltage Vpp between a time period when the down counter counts ‘255’ and when the up counter counts ‘255.’ Therefore, the time period for maintaining the data signal at the voltage Vpp is varied by the clocks of the counter according to gray levels. Thus, the data driver employs the down counter and the up counter to represent 255 gray levels. Also, the time period for maintaining the data signal at the voltage Vpp increases symmetrically with respect to the middle of the on time of one line (or one line on-time) as the gray level becomes higher.

Referring to FIG. 2B, only the down counter operates like that of FIG. 2A, thereby generating the data signal.

Referring to FIG. 2C, only the up counter operates like that of FIG. 2A, thereby generating the data signal.

The foregoing PWM methods can be easily driven because of a linear relation between a pulse width and an emission current, but the power consumption in charging and discharging of electricity to apply an electric field between a gate electrode and a cathode electrode is high. Further, the PWM methods represent the gray levels by dividing a relatively short time period for applying the scan signal. Here, as the gray level becomes higher, the on-time for applying the scan signal may be too short. That is, a gap between the gray levels may become so short that it becomes difficult to properly represent all the gray levels. Further, as the resolution of the flat panel display device increases, the on-time corresponding to one line decreases, so that the time period that can be used to represent the gray levels is even more constrained as compared with the flat panel display device having a relatively low resolution.

### SUMMARY OF THE INVENTION

Accordingly, it is an aspect of the present invention to provide a flat panel display device and a data signal generating method thereof, in which data signals are different in voltage levels, thereby enhancing efficiency of representing a gray level and reducing power consumption.

In an exemplary embodiment of the present invention, a flat panel display device includes: a display region for receiving a data signal and a scan signal to display an image; a data driver for generating the data signal based on a video signal and for supplying the data signal to the display region; and a scan driver for generating the scan signal and for supplying the scan signal to the display region, wherein the data driver is adapted to adjust a voltage level of the data signal by at least one upper bit of the video signal and to adjust a pulse width of the data signal by at least one lower bit of the video signal to control brightness.

In another exemplary embodiment of the present invention, a data driver includes: a shift register for receiving a video signal; a latch for outputting at least one upper bit and at least one lower bit of the video signal in parallel, at least a portion of the video being divided into the upper bit and the lower bit; a counter for counting a number of clocks in sequence; a comparator for receiving the lower bit of the video signal, for comparing the number counted by the counter with the lower bit, and for outputting a signal about when the counted number of clocks corresponds with the lower bit; a voltage selector for determining a voltage level of the data signal based on the upper bit of the video signal; and a level shifter for applying the data signal to a display region about when the voltage level of the data signal is determined by the voltage selector and the comparator outputs the signal.

In still another exemplary embodiment of the present invention, a data driver includes: a shift register for receiving a video signal; a latch for outputting at least one upper bit and at least one lower bit of the video signal in parallel, at least a portion of the video signal being divided into the upper bit and the lower bit; a plurality of counters for counting a number of clocks, the plurality of counters being different from one another in time taken to count the number of clocks; a comparator for receiving the lower bit of the video signal, for comparing the number counted by one of the counters with the lower bit, and for outputting a signal about when the counted number of clocks corresponds with the lower bit; a voltage selector for determining an amplitude of the data signal based on the upper bit of the video signal; and a level shifter for applying the data signal to the display region about when the amplitude of the data signal is determined by the voltage selector and the comparator outputs the signal.

In yet another exemplary embodiment of the present invention, a method of generating a data signal based on a video signal and representing a gray level, the method includes: receiving the video signal; dividing the video signal into at least one upper bit and at least one lower bit; determining a voltage of the data signal based on the upper bit; and determining a pulse width of the data signal based on the lower bit.

In still another exemplary embodiment of the present invention, a method of generating a data signal includes: dividing gray levels of video signals into a plurality of ranges; setting different reference voltages and different counting time periods according to the ranges of the gray levels; selecting at least one of the ranges of the gray levels based on at least one upper bit of at least one of the video signals; and determining a voltage level and a pulse width of a data signal based on at least one of the reference voltages and at least one of the counting time periods corresponding to the selected range.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a block diagram of a conventional data driver that generates a data signal based on a PWM method;

FIGS. 2A, 2B, and 2C are timing diagrams illustrating PWM driving methods of the conventional data driver shown in FIG. 1;

FIG. 3 is a block diagram of a data driver according to a first embodiment of the present invention;

FIGS. 4A, 4B, 4C, 4D, 4E, and 4F are waveforms based on operations of the data driver according to the first embodiment of the present invention;

FIG. 5 is a block diagram of a data driver according to a second embodiment of the present invention;

FIG. 6 is a waveform based on an operation of the data driver according to the second embodiment of the present invention; and

FIG. 7 illustrates a flat panel display device employing the data driver according to an embodiment of the present invention.

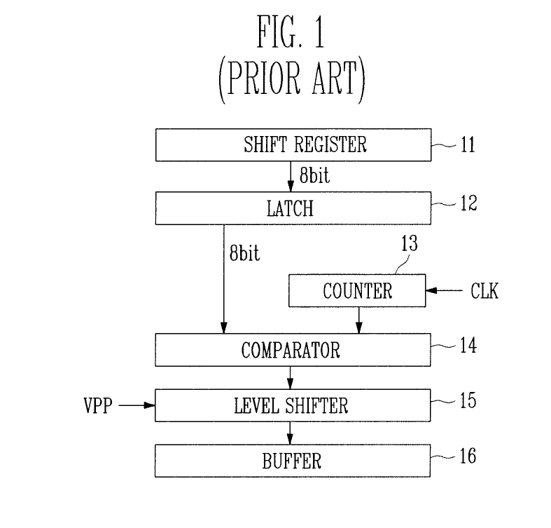

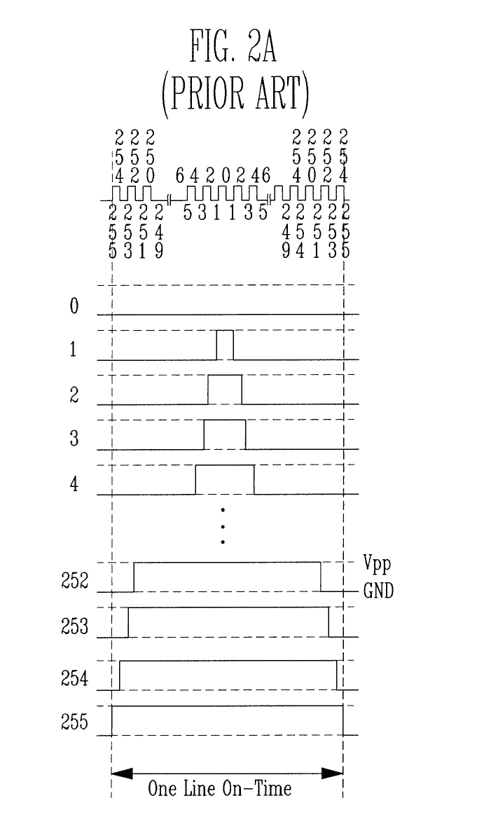

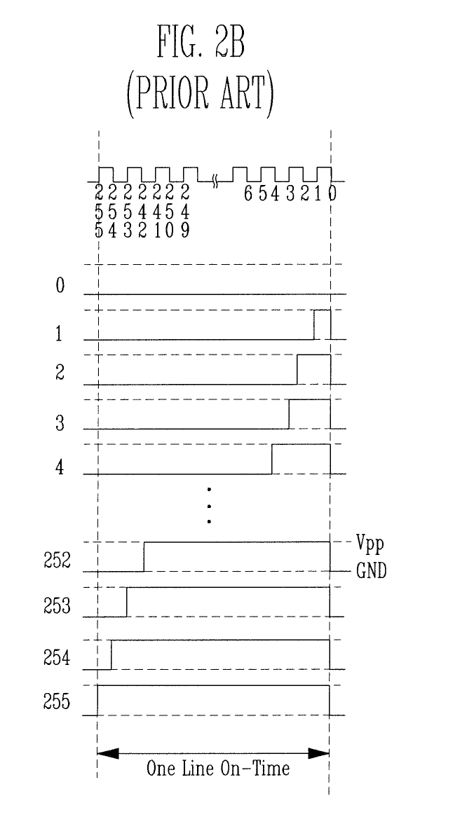

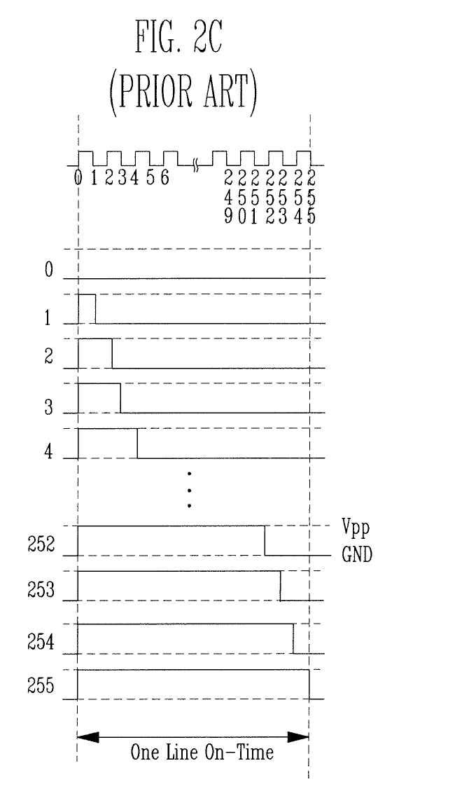

### DETAILED DESCRIPTION

In the following detailed description, only certain exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, and not restrictive.

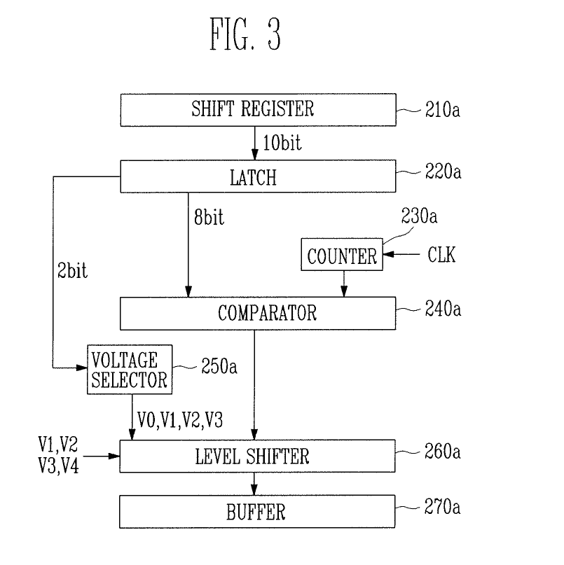

FIG. 3 is a block diagram of a data driver according to a first embodiment of the present invention. Referring to FIG. 3, the data driver includes a shift register 210a, a latch 220a, a counter 230a, a comparator 240a, a voltage selector 250a, a level shifter 260a, and a buffer 270a.

The shift register 210a receives a video signal of 10 bits for representing a gray level from ‘0’ to ‘1023’ in series, and transmits the video signal to the latch 220a. The latch 220a receives the video signal of 10 bits in series and outputs the video signal in parallel. In more detail, the latch 220a transmits the lower 8 bits of the video signal to the comparator 240a, and transmits the upper 2 bits of the video signal to the voltage selector 250a. The counter 230a includes an up counter and a down counter, or includes either the up counter or the down counter. The counter 230a counts clocks CLK. Further, the comparator 240a compares a value of an input video signal with the number counted by the counter 230a, and then outputs a signal. Here, it is shown that the voltage selector 250a uses a signal of 2 bits to output a selection signal for selecting a voltage from among a total four voltages V0, V1, V2 and V3, but the present invention is not thereby limited.

By the signal output from the comparator 220a and the selection signal output from the voltage selector 250a, the level shifter 260a selects a low voltage from among the voltages V0, V1, V2 and V3, and a high voltage from among the voltages V1, V2, V3 and V4. When the voltage V0 is selected as the low voltage, the high voltage is the voltage V1. When the voltage V1 is selected as the low voltage, the high voltage is the voltage V2. When voltage V2 is selected as the low voltage, the high voltage is the voltage V3. When voltage V3 is selected as the low voltage, the high voltage is the voltage V4. Therefore, the level shifter 260a outputs a signal having a certain (or predetermined) voltage and a certain (or predetermined) on-time with the comparator 220a and the voltage selector 250a. Then, the signal output from the level shifter 260a is transmitted to the buffer 270a, thereby allowing the data signal to be output.

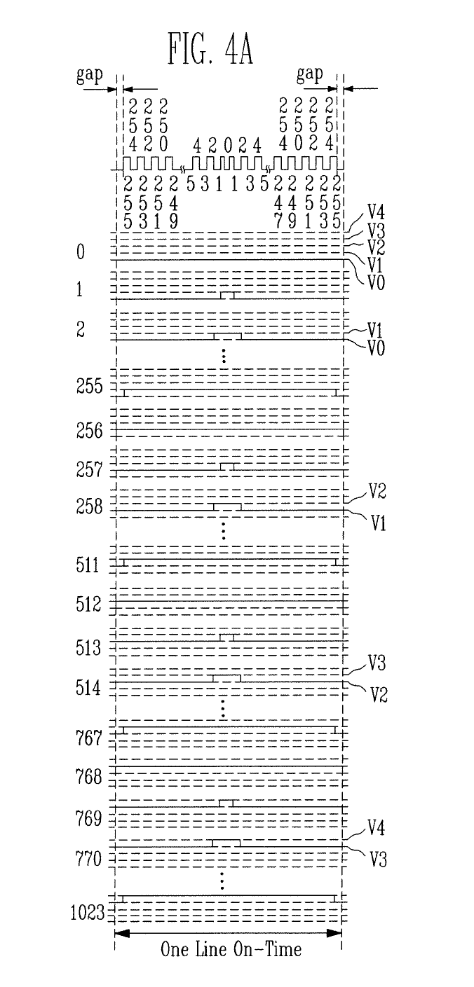

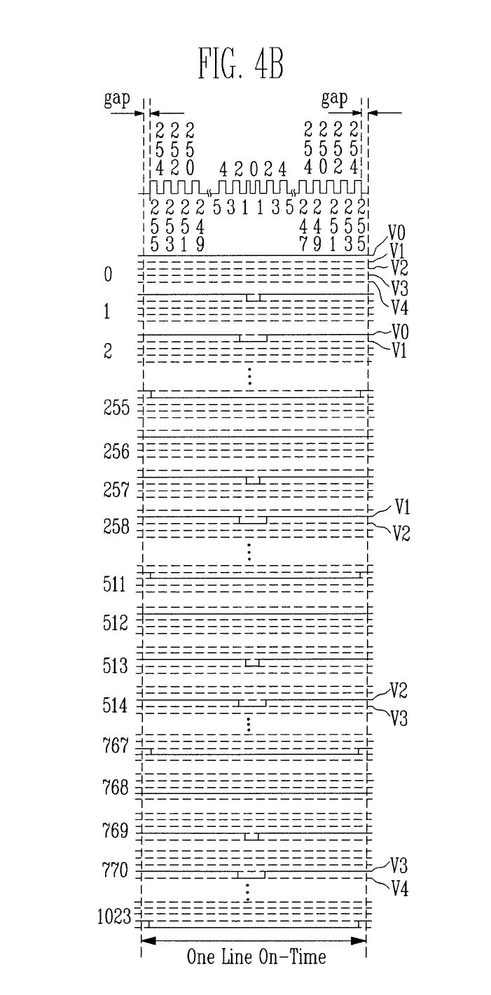

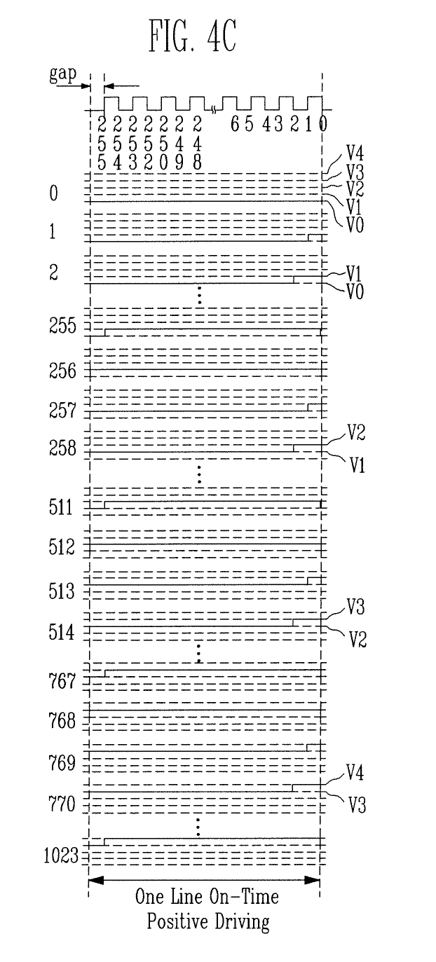

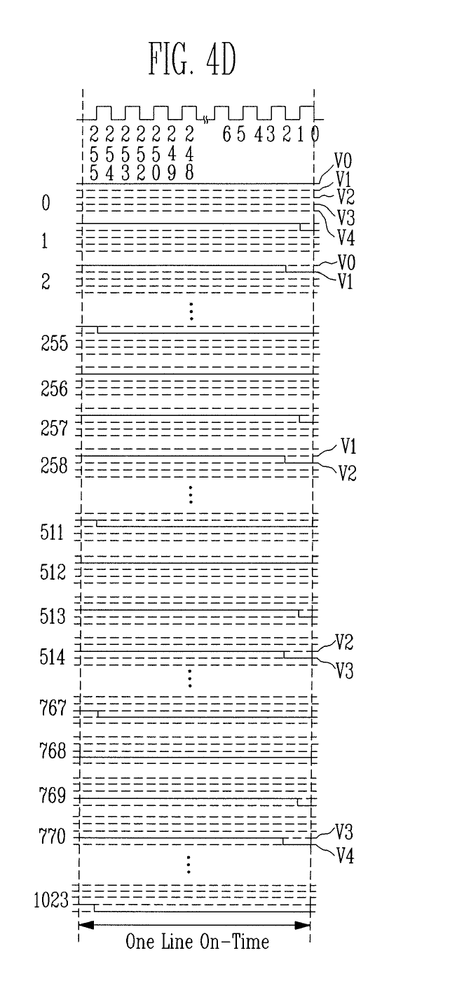

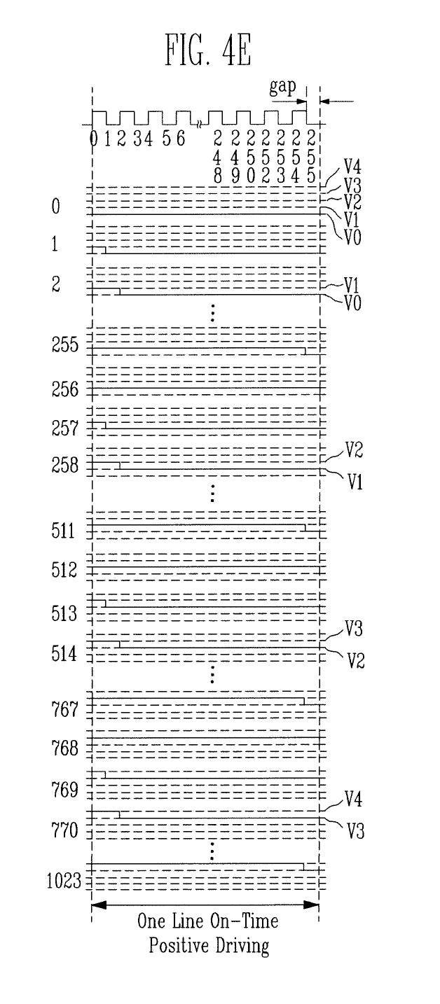

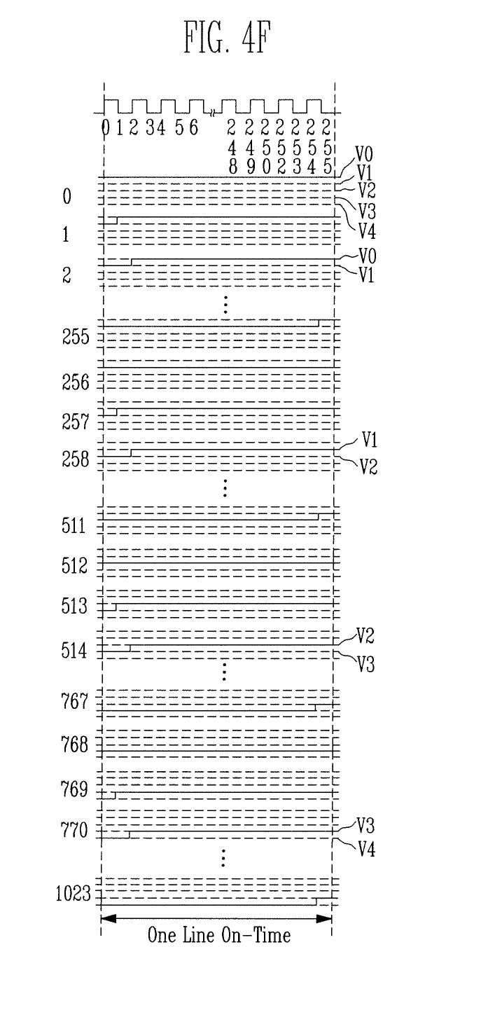

FIGS. 4A through 4F are waveforms based on operation of the data driver according to the first embodiment of the present invention. Referring to FIGS. 4A through 4F, the data driver 200 receives a video signal of 10 bits, and represents a gray scale of 10 bits on the basis of the pulse width and the amplitude of a data signal.

In the case where the input video signal has a gray level of ‘0,’ the counter 230 counts clocks while a scan driver 300 maintains one line in on-time. The counter 230 counts a rising time and a falling time of the clocks. In more detail, the down counter first operates to count numbers from ‘255’ to ‘0’ in sequence, and the up counter then operates to count numbers from ‘0’ to ‘255’ in sequence.

Further, the voltage selector 250a outputs a selection signal to select (or outputs) a voltage from among four voltages as a reference (or low) voltage of the data signal. Here, the voltage selector 250a selects the reference (or low) voltage from among the four voltages through the upper 2 bits of the input gray level of the video signal output from the latch 220. When the upper 2 bits are 0₍₁₀₎, the voltage V0 is selected as the reference voltage. When the upper 2 bits are 1₍₁₀₎, the voltage V1 is selected as the reference voltage. When the upper 2 bits are 2₍₁₀₎, the voltage V2 is selected as the reference voltage. When the upper 2 bits are 3₍₁₀₎, the voltage V3 is selected as the reference voltage.

In the case where the input video signal has a gray level of ‘0,’ the upper 2 bits of the 10 bits are of 00₍₂₎, so that the voltage V0 is selected as the low voltage of the data signal. Accordingly, the voltage V1 is selected as the high voltage of the data signal, and the lower 8 bits are of 00000000₍₂₎. The down counter operates to count from ‘255’ to ‘0’ and then the up counter operates to count from ‘0’ to ‘255.’ Here, the signal compared by the comparator is ‘0’, so that the data signal maintains the voltage V0 during an entire on-time of one line (or one line on-time).

In the case where the input video signal has a gray level of ‘2,’ the upper 2 bits among 10 bits are of 00₍₂₎, so that the voltage V0 is selected as the low voltage of the data signal. Accordingly, the voltage V1 is selected as the high voltage of the data signal, and the lower 8 bits are of 00000010₍₂₎. The down counter operates to count from ‘255’ to ‘0’ and then the up counter operates to count from ‘0’ to ‘255.’ Here, the signal compared by the comparator is 2₍₁₀₎, so that the data signal maintains the voltage V0 until the down counter counts 2₍₁₀₎. Then, the data signal maintains the voltage V1 during the time period between when the down counter counts 2₍₁₀₎ and when the up counter counts 2₍₁₀₎. After the up counter counts 2₍₁₀₎, the data signal returns to and maintains the voltage V0. Therefore, the data signal maintains the voltage V1 for a certain (or predetermined) time period with respect to the middle of the on-time of one line (or one line on-time or while the one line is in on-time), and maintains the voltage V0 for the rest of the time.

In the case where the input video signal has a gray level of ‘258,’ the upper 2 bits among 10 bits are of 01₍₂₎, so that the voltage V1 is selected as the low voltage of the data signal. Accordingly, the voltage V2 is selected as the high voltage of the data signal, and the lower 8 bits are of 00000010₍₂₎. The down counter operates to count from ‘255’ to ‘0’ and then the up counter operates to count from ‘0’ to ‘255.’ Here, the signal compared by the comparator is 2₍₁₀₎, so that the data signal maintains the voltage V1 until the down counter counts 2₍₁₀₎. Then, the data signal maintains the voltage V2 during the time period between when the down counter counts 2₍₁₀₎ and when the up counter counts 2₍₁₀₎. After the up counter counts 2₍₁₀₎, the data signal returns to and maintains the voltage V1. Therefore, the data signal maintains the voltage V2 for a certain (or predetermined) time period with respect to the middle of the on-time of one line, and maintains the voltage V1 for the rest of time.

In the case where the input video signal has a gray level of ‘514,’ the upper 2 bits among 10 bits are of 10₍₂₎, so that the voltage V2 is selected as the low voltage of the data signal. Accordingly, the voltage V3 is selected as the high voltage of the data signal, and the lower 8 bits are of 00000010₍₂₎. The down counter operates to count from ‘255’ to ‘0’ and then the up counter operates to count from ‘0’ to ‘255.’ Here, the signal compared by the comparator is 2₍₁₀₎, so that the data signal maintains the voltage V2 until the down counter counts 2₍₁₀₎. Then, the data signal maintains the voltage V3 during the time period between when the down counter counts 2₍₁₀₎ and when the up counter counts 2₍₁₀₎. After the up counter counts 2₍₁₀₎, the data signal returns to and maintains the voltage V2. Therefore, the data signal maintains the voltage V2 for a certain (or predetermined) time period with respect to the middle of the on-time of one line, and maintains the voltage V2 for the rest of time.

In the case where the input video signal has a gray level of ‘770,’ the upper 2 bits among 10 bits are of 11₍₂₎, so that the voltage V3 is selected as the low voltage of the data signal. Accordingly, the voltage V4 is selected as the high voltage of the data signal, and the lower 8 bits are of 00000010₍₂₎. The down counter operates to count from ‘255’ to ‘0’ and then the up counter operates to count from ‘0’ to ‘255.’ Here, the signal compared by the comparator is 2₍₁₀₎, so that the data signal maintains the voltage V3 until the down counter counts 2₍₁₀₎. Then, the data signal maintains a voltage V4 during the time period between when the down counter counts 2₍₁₀₎ and when the up counter counts 2₍₁₀₎. After the up counter counts 2₍₁₀₎, the data signal returns to and maintains the voltage V3. Therefore, the data signal maintains the voltage V4 for a certain (or predetermined) time period with respect to the middle of the on-time of one line, and maintains the voltage V3 for the rest of time.

In addition, the on-time of the video signal corresponding to one line (or the on-time of one line or one line on-time) should be longer than the counting time of the counter. If the on-time of one line is equal to the counting time of the counter, there is a problem that pairs of gray levels ‘255’ and ‘256’, ‘511’ and ‘512’, and ‘767’ and ‘768’ of the video signal may be represented as if they are the same.

By contrast, in one embodiment of the invention, when the on-time of the video signal corresponding to one line (or the on-time of one line) is longer than the counting time of the counter by the time of at least one clock, the gray level of ‘255’ is represented by one time period (or section) for maintaining the voltage V1 and by another time period for maintaining the voltage V0, but the gray level of ‘256’ is represented by only one time period (or section) for maintaining the voltage V1. Therefore, the gray levels of ‘255’ and ‘256’ can have a difference in brightness. Likewise, the gray levels of ‘511’ and 512′ and the gray levels of ‘767’ and ‘768’ can have differences in brightness.

Thus, although a gray scale higher than 8 bits is used to represent relatively more video signals than can be represented by a gray scale of 8 bits , a reference voltage of a data signal of one embodiment of the invention can be varied to correspond to the gray level of a video signal so that the amplitude of the data signal can also be varied according to the gray level of the video signal, thereby allowing the pulse width of the video signal represented by the gray scale higher than 8 bits to vary in a manner similar to a video signal represented by the gray scale of 8 bits. That is, even though data of the video signal has become larger to represent a larger (or higher) number of gray levels, relative difference in the pulse width of the data signal is not reduced for each of the gray levels.

In addition, the smaller a difference in the pulse width between two data signals due to a difference between the gray levels is, the better a response characteristic of the data signals needs to be. However, according to one embodiment of the present invention, since the difference in the pulse width is not reduced, there is no need to increase the amount of current in order to reduce or prevent a delay (or to improve a response characteristic of the data signals), thereby decreasing power consumption.

FIG. 4B shows a negative driving waveform of when the counter includes both the up counter and the down counter. FIGS. 4C and 4D respectively show positive driving and the negative driving waveforms of when the counter includes only the down counter. FIGS. 4E and 4F respectively show positive driving and negative driving waveforms of when the counter includes only the up counter.

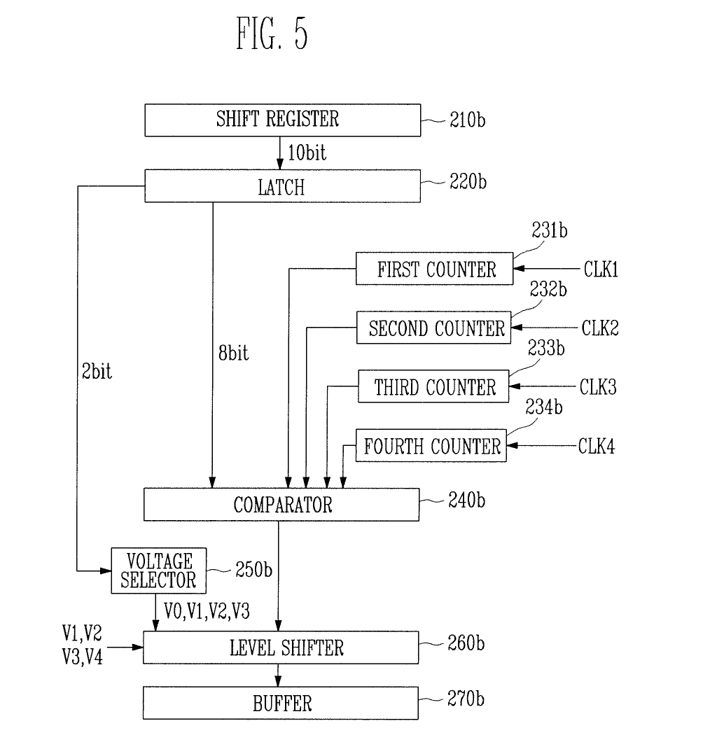

FIG. 5 is a block diagram of a data driver according to a second embodiment of the present invention. Referring to FIG. 5, the data driver includes a shift register 210b, a latch 220b, first, second, third, and fourth counters 231b, 232b, 233b and 234b, a comparator 240b, a voltage selector 250b, a level shifter 260b, and a buffer 270b.

The shift register 210b receives a video signal of 10 bits in series, and transmits the video signal to the latch 220b. The latch 220b receives the video signal of 10 bits in series and outputs the video signal in parallel. In more detail, the latch 220b transmits the lower 8 bits of the video signal to the comparator 240b, and transmits the upper 2 bits of the video signal to the voltage selector 250b. Each of the first through fourth counters 231b, 232b, 233b and 234b includes an up counter and a down counter, or includes either the up counter or the down counter. Each of the first through fourth counters 231b, 232b, 233b and 234b counts clocks. One of the first through fourth counters 231b, 232b, 233b and 234b is selected by the upper 2 bits of the video signal. The first through fourth counters 231b, 232b, 233b and 234b respectively receive first clocks CLK1, second clocks CLK2, third clocks CLK3 and fourth clocks CLK4 and count them. Here, the first clocks CLK1, the second clocks CLK2, the third clocks CLK3, and the fourth clocks CLK4 are different in a period from one another, so that times taken to count the same number are different. Accordingly, emission times between the gray levels corresponding to the amplitude of the data signal are differently set. Further, the comparator 240b compares a value of an input video signal with the numbers counted by the first through fourth counters 231b, 232b, 233b and 234b, and then outputs a signal. The voltage selector 250b uses a signal of 2 bits in selecting a voltage. It is shown that the voltage selector 250b outputs a selection for selecting a voltage from among a total of four voltages V0, V1, V2 and V3 based on the signal of 2 bit, but the present invention is not thereby limited.

By the signal output from the comparator 220b and the selection signal output from the voltage selector 250b, the level shifter 260b selects a low voltage from among the voltages V0, V1, V2 and V3, and a high voltage from among the voltages V1, V2, V3 and V4. When the voltage V0 is selected as the low voltage, the high voltage is the voltage V1. When the voltage V1 is selected as the low voltage, the high voltage is the voltage V2. When the voltage V2 is selected as the low voltage, the high voltage is the voltage V3. When the voltage V3 is selected as the low voltage, the high voltage is the voltage V4. Therefore, the level shifter 260b outputs a signal having a certain (or predetermined) voltage and a certain (or predetermined) on-time with the comparator 220b and the voltage selector 250b. Then, the signal output from the level shifter 260b is transmitted to the buffer 270b, thereby allowing the data signal to be output.

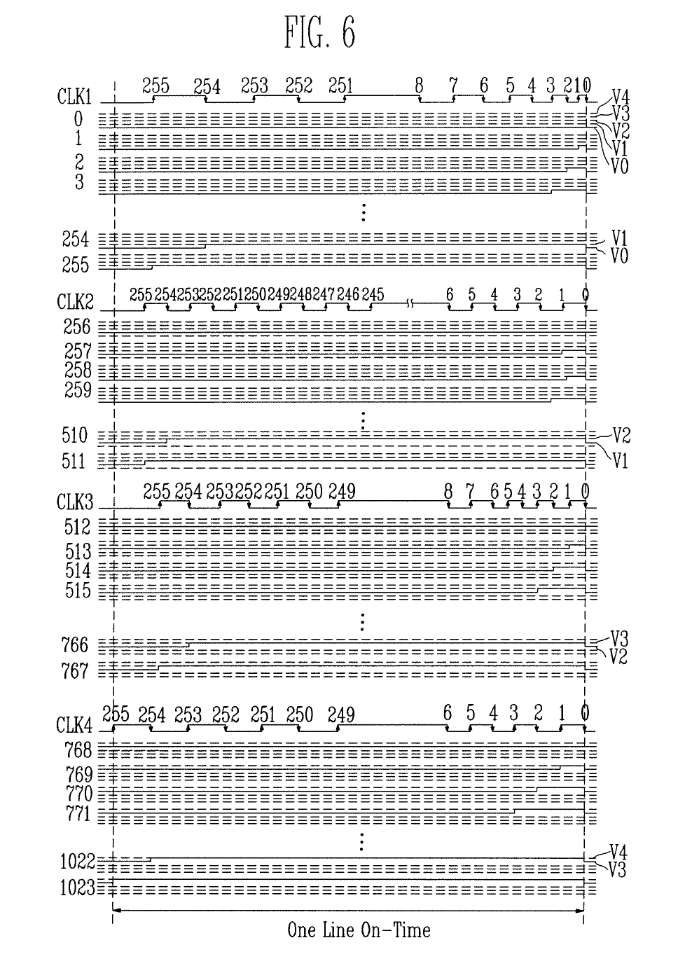

FIG. 6 is a waveform based on operation of the data driver according to the second embodiment of the present invention. The first through fourth clocks CLK1, CLK2, CLK3 and CLK4 different in a period from each other are input to the first through fourth counters 231b, 232b, 233b and 234b. Therefore, the emission time due to difference between the gray levels of the data signal is varied according to which one of the first through fourth clocks CLK1, CLK2, CLK3 and CLK4 is selected and respectively counted by the first through fourth counters 231b, 232b, 233b and 234b of the data driver. Here, it is shown that each of the first through fourth counters 231b, 232b, 233b and 234b includes only the down counter, but the present invention is not thereby limited. For example, each of the first through fourth counters 231b, 232b, 233b and 234b may include the up counter, or may include both the up counter and the down counter.

When the input gray level of the video signal can range from ‘0’ to ‘255,’ the first counter 231b receiving the first clock CLK1 is selected. When the input gray level of the video signal can range from ‘256’ to ‘511,’ the second counter 232b receiving the second clock CLK2 is selected. When the input gray level of the video signal can range from ‘512’ to ‘767,’ the third counter 233b receiving the third clock CLK3 is selected. When the input gray level of the video signal can range from ‘768’ to ‘1023,’ the fourth counter 234b receiving the fourth clock CLK4 is selected. Thus, representing the gray level of the data signal is divided into a step of representing the gray levels from ‘0’ to ‘255,’ a step of representing the gray levels from ‘256’ to ‘511,’ a step of representing the gray levels from ‘512’ to ‘767,’ and a step of representing the gray levels from ‘768’ to ‘1023.’ Here, the times taken for the first through fourth counters 231b, 232b, 233b and 234b to count the same number are different from each other by the respective periods of the first through fourth clocks CLK1, CLK2, CLK3 and CLK4, so that the emission time corresponding to one gray level difference is varied according to which one of the first through fourth counters 231b, 232b, 233b and 234b operates. Thus, the emission time corresponding to one gray level difference can be further varied by the various steps of representing the gray level of the data signal.

In addition, the on-time of the video signal corresponding to one line (or the on-time of one line or one line on-time) should be longer than the counting time of the counter. The reason for this was described above with reference to FIGS. 4A through 4F.

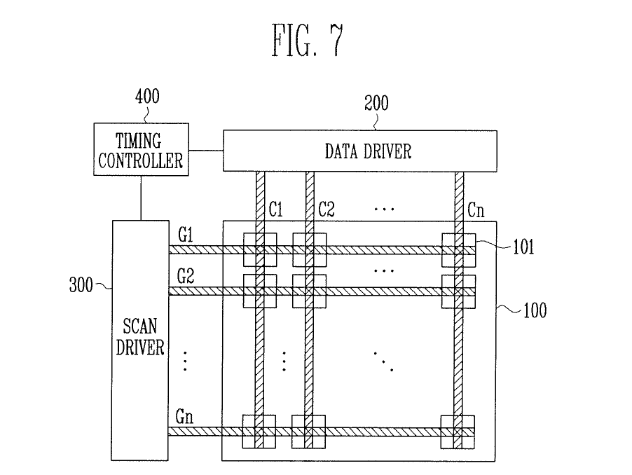

FIG. 7 illustrates a flat panel display device employing the data driver according to an embodiment of the present invention. Referring to FIG. 7, an electron emission display device is shown as an example of the flat panel display device, but the present invention is not thereby limited. For example, the flat panel display device may be a plasma display panel.

In FIG. 7, the electron emission display includes a display region 100, the data driver 200, a scan driver 300 and a timing controller 400.

The display region 100 includes a plurality of pixels 101 in regions around where a plurality of cathode electrodes C1, C2, . . . , Cn cross (or intersect) a plurality of gate electrodes G1, G2, . . . , Gn. Each of the pixels 101 includes an electron emitting device. The electron emitting device emits electrons toward an anode, so that the electrons collide with the anode, thereby allowing a fluorescent material of the anode to emit light. Thus, an image is displayed. The gray level of the displayed image is varied according to values of input digital video signals. The gray levels according to the values of the digital video signals can be represented by a method of using differences in emission times based on a PWM method, and a method of using differences in the voltages between the cathode electrodes C1, C2, . . . , Cn and the gate electrodes G1, G2, . . . , Gn by adjusting a voltage of the data signal. For example, the gray levels of the video signals are divided into a plurality of ranges, and the differences in voltages between the cathode electrodes C1, C2, . . . , Cn and the gate electrodes G1, G2, . . . , Gn are adjusted according to the ranges of the gray levels.

The data driver 200 generates a data signal based on a video signal and is connected with the cathode electrodes C1, C2, . . . , Cn, so that the data signal can be supplied to the display region 100. Thus, the display region 100 emits light based on the data signal. The data signal generated by the data driver 200 can have a plurality of voltage levels corresponding to the gray level of the video signal, and the gray level of the video signal can be categorized into the plurality of ranges, thereby allowing the data signal to have a voltage level that can be varied according to one or more of the ranges of the gray levels. When the data signal has a voltage level corresponding to one of the ranges of the gray levels, the voltage applied to the cathode electrode C1, C2, . . . , Cn is varied, so that the difference in the voltage between the cathode electrodes C1, C2, . . . , Cn and the gate electrodes G1, G2, . . . , Gn is varied according to the one of the ranges of the gray levels, thereby causing brightness difference according to the ranges of the gray levels.

In addition, each pixel of the electron emission display includes a parasitic capacitance (or capacitor). Therefore, power is consumed in charging and discharging the parasitic capacitance, thereby increasing the power consumption. The amount of the power consumed in charging and discharging the parasitic capacitance can be calculated by the following [Equation 1].

P_{d}=n·m·C_{kg}·V_{H}²·F_{clk} [Equation 1]

Where, n is the number of row lines; m is the number of column lines, C_{kg} is capacitance between the gate electrode and the cathode electrode, V_{H} is a voltage level of the data signal applied to the column lines, F_{clk} is a driving frequency of the data driver for the column lines.

In general, when the voltage level of the data signal becomes higher, the power consumption increases. However, according to one embodiment of the present invention, the voltage level V_{H} is adjusted according to the ranges of the gray levels, so that it can have |V1-GND|, |V2-V1|, |V3-V2|, or |V4-V3|. Thus, the power consumption does not increase even though the voltage level of the data signal becomes higher.

The scan driver 300 is connected with the gate electrodes G1, G2, . . . , Gn and supplies scan signals to the display region 100. Therefore, the scan driver 300 drives the display region 100 to emit light in sequence for a certain time per unit of a horizontal line based on a line scanning method, thereby displaying an image on an entire screen without increasing the production cost and the power consumption. Further, in one embodiment, the scan driver 300 applies (or leaves) a blank (or a blank signal) between a previous scan signal and a current scan signal so as to prevent the scan signals from overlapping due to the rising time and the falling time of each of the scan signals.

The timing controller 400 transmits (or applies) a video signal, a data control signal, a scan control signal, etc. to the data driver 200 and the scan driver 300, and controls the data driver 200 and the scan driver 300 to operate, thereby allowing the display region 100 to display an image thereon.

The present invention provides a flat panel display device and a data signal generating method thereof, in which a high gray level can be represented without reducing an emission time between the gray levels, so that the efficiency of representing the gray level is further enhanced, thereby improving a contrast. Further, additional electric current is not needed, thereby reducing a power consumption.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. A flat panel display device comprising:
a display region for receiving a data signal and a scan signal to display an image;
a data driver for generating the data signal based on a video signal and for supplying the data signal to the display region; and
a scan driver for generating the scan signal and for supplying the scan signal to the display region,
wherein the data driver is adapted to adjust a voltage level of the data signal by at least one upper bit of the video signal and to adjust a pulse width of the data signal by at least one lower bit of the video signal to control brightness.

2. The flat panel display device according to claim 1, wherein the data driver comprises:
a shift register for receiving the video signal;
a latch for outputting the upper bit and the lower bit of the video signal in parallel, at least a portion of the video signal being divided into the upper bit and the lower bit;
a counter for counting a number of clocks in sequence;
a comparator for receiving the lower bit of the video signal, for comparing the number counted by the counter with the lower bit, and for outputting a signal about when the counted number of clocks corresponds with the lower bit;
a voltage selector for determining a voltage level of the data signal based on the upper bit of the video signal; and
a level shifter for applying the data signal to the display region about when the voltage level of the data signal is determined by the voltage selector and the comparator outputs the signal.

3. The flat panel display device according to claim 2, wherein the counter counts the number of clocks corresponding to the lower bit during an on-time.

4. The flat panel display device according to claim 3, wherein the on-time is a time period taken for the counter to count a number at least one clock higher than the counted number of clocks corresponding to the lower bit.

5. The flat panel display device according to claim 1, wherein the data driver comprises:
a shift register for receiving the video signal;
a latch for outputting the upper bit and the lower bit of the video signal in parallel, at least a portion of the video signal being divided into the upper bit and the lower bit;
a plurality of counters for counting a number of clocks, the plurality of counters being different from one another in time taken to count the number of clocks;
a comparator for receiving the lower bit of the video signal, for comparing the number counted by one of the counters with the lower bit, and for outputting a signal about when the counted number of clocks corresponds with the lower bit;
a voltage selector for determining an amplitude of the data signal based on the upper bit of the video signal; and
a level shifter for applying the data signal to the display region about when the amplitude of the data signal is determined by the voltage selector and the comparator outputs the signal.

6. The flat panel display device according to claim 5, wherein the clocks respectively counted by the plurality of counters differ in a period from one another.

7. The flat panel display device according to claim 5, wherein each of the plurality of counters counts the number of clocks corresponding to the lower bit during an on-time.

8. The flat panel display device according to claim 7, wherein the on-time is a time period taken for at least one of the counters to count a number at least one clock higher than the counted number of clocks corresponding to the lower bit.

9. The flat panel display device according to claim 1, wherein the scan driver leaves a blank signal between a previous scan signal and a current scan signal.

10. The flat panel display device according to claim 1, wherein the display region comprises an electron emitting device.

11. A data driver comprising:
a shift register for receiving a video signal;
a latch for outputting at least one upper bit and at least one lower bit of the video signal in parallel, at least a portion of the video being divided into the upper bit and the lower bit;
a counter for counting a number of clocks in sequence;
a comparator for receiving the lower bit of the video signal, for comparing the number counted by the counter with the lower bit, and for outputting a signal about when the counted number of clocks corresponds with the lower bit;
a voltage selector for determining a voltage level of the data signal based on the upper bit of the video signal; and
a level shifter for applying the data signal to a display region about when the voltage level of the data signal is determined by the voltage selector and the comparator outputs the signal.

12. The data driver according to claim 11, wherein the counter counts the number of clocks corresponding to the lower bit during an on-time.

13. The data driver according to claim 12, wherein the on-time is a time period taken for the counter to count a number at least one clock higher than the counted number corresponding to the lower bit.

14. A method of generating a data signal based on a video signal and representing a gray level, the method comprising:
receiving the video signal;
dividing the video signal into at least one upper bit and at least one lower bit;
determining a voltage of the data signal based on the upper bit; and
determining a pulse width of the data signal based on the lower bit.

15. The method according to claim 14, wherein the determining the pulse width of the data signal comprises counting a number of clocks in sequence and outputting the data signal when the lower bit corresponds with the counted number of clocks.

16. The method according to claim 15, wherein the determining the pulse width of the data signal comprises outputting the data signal about when the counted number of clocks corresponds with the lower bit of the video signal, and wherein a time period taken to count the number of clocks is varied to correspond to the upper bit of the video signal.

17. The method according to claim 14, wherein the determining the pulse width of the data signal comprises counting a number of clocks in sequence in a time period shorter than an on-time.

18. A method of generating a data signal, comprising:
dividing gray levels of video signals into a plurality of ranges;
setting different reference voltages and different counting time periods according to the ranges of the gray levels;
selecting at least one of the ranges of the gray levels based on at least one upper bit of at least one of the video signals; and
determining a voltage level and a pulse width of a data signal based on at least one of the reference voltages and at least one of the counting time periods corresponding to the selected range.

19. The method according to claim 18, wherein the determining the pulse width of the data signal comprises determining the pulse width of the data signal based on at least one lower bit of the video signal and a time period taken to count a number of clocks corresponding to the lower bit.
